(19) United States
(12) Patent Application Publication
(10) Pub. No.: US 2007/0231590 A1
(43) Pub. Date: Oct. 4, 2007

(54) Method of Bonding Metals to Ceramics

(75) Inventor: John B. Blum, Chester, VT (US)

Correspondence Address: MINTZ, LEVIN, COHN, FERRIS, GLOVSKY;AND POPEO, P.C., ONE FINANCIAL CENTER, BOSTON, MA, 02111, US

(73) Assignee: STELLAR INDUSTRIES CORP., Millbury, MA (US)

(21) Appl. No.: 11/565,313

(22) Filed: Nov. 30, 2006

Related U.S. Application Data
(60) Provisional application No. 60/787,960, filed on Mar. 31, 2006.

(51) Int. Cl. B32B 9/00; B32B 19/00

(52) U.S. Cl. 428/469; 428/698; 428/701; 428/702; 427/383.1; 427/402

(57) ABSTRACT

A metal layer is bonded to a ceramic substrate in a method, wherein a first metal layer (e.g., a copper film) is first applied to a surface of the ceramic substrate. The ceramic substrate, with the first metal layer applied thereto, is then heated in an atmosphere including oxygen (e.g., to a temperature below the eutectic temperature of the metal oxide) to form an adhesion-promotion layer. A second metal layer (e.g., a copper foil) is then bonded to the adhesion-promotion layer. Where the metal is copper, the adhesion promotion layer can include copper oxide and copper aluminum oxide.

### RELATED APPLICATION

This application claims the benefit of U.S. Provisional Application No. 60/787,960, filed Mar. 31, 2006, the entire teachings of which are incorporated herein by reference.

### BACKGROUND

As the complexity of electronic circuit functions increases and as the physical size of the circuitry components decreases, heat dissipation across the circuit becomes increasingly important. One useful method for heat dissipation is to combine the electrical and thermal conductivities of a metallic layer with the electrical insulation and thermal stability of ceramic substrates.

In U.S. Pat. Nos. 3,766,634 and 3,911,553, a eutectic layer is used to directly bond metal foils onto ceramic substrates. This method has been found to be useful, especially in bonding copper to oxide ceramics (e.g., Al₂O₃ and BeO). In this process, a copper foil, which may have intentionally been oxidized via thermal or chemical means, is placed adjacent to the ceramic substrate surface; and the combination is heated in a controlled atmosphere to a temperature above the copper/copper oxide eutectic (approximately 1065° C.), but below the melting point of copper (approximately 1083° C.). At this elevated temperature, a liquid is formed, which upon subsequent cooling produces a strong bond between the copper foil and ceramic substrate. The resultant bonding can be envisaged as a series of the following bonds: copper to copper oxide and copper oxide to oxide ceramic.

This method was expanded in U.S. Pat. No. 4,563,383 to include producing a ceramic-copper-ceramic laminate structure and by U.S. Pat. No. 5,490,627 to include direct bonding of copper composites to ceramic substrates. In order to reduce imperfections or poor bonding due to gases formed or entrapped during the direct bonding process, grooved or perforated copper foils may be used, as described in U.S. Pat. Nos. 4,409,278; 4,591,401; and 5,418,002.

However, the direct bonding method per se is thought to not be possible for non-oxide ceramics because an oxide surface on the ceramic substrate is generally needed for direct bonding to occur via these methods. Typically, what has been done in practice is to thermally oxidize the ceramic surface at elevated temperatures prior to bonding, as described in U.S. Pat. Nos. 4,693,409; 5,150,830; and 5,418,002, wherein copper is bonded to aluminum nitride. The resultant bonding in this case can be envisaged as the following series of bonds: copper to copper oxide, copper oxide to ceramic oxide, and ceramic oxide to non-oxide ceramic.

A concern when using the above-mentioned procedures is that the nature of the bonding layer is critical to the performance of the bond. The bonding layer between the copper foil and the ceramic substrate is formed during the bonding process and thus is constrained by the conditions necessary to form a good bond. The temperature range for bonding is limited by the eutectic and liquidus temperatures in the copper-oxygen system. If an excess of oxygen is present during bonding, the copper foil may melt. If a deficit of oxygen is present during bonding, the copper foil will not adhere to the ceramic substrate. In addition, as mentioned above, gases generated during the bonding process can become trapped, leading to incomplete bonding and deformation of the copper foil. Even if a reasonable strength is obtained after bonding, further processing during electronic circuit preparation (e.g., exposing the bonded substrate to reducing conditions at elevated temperatures during a soldering operation) may decrease the strength and reliability of the copper-ceramic bond.

### SUMMARY

As discussed above, a limitation of the direct-bonding process as currently practiced is that the bonding layer is formed during the bonding procedure itself. In the methods described, below, an adhesion-promotion layer is formed by depositing a first metal layer (e.g., a copper film) onto the surface of the ceramic substrate followed by heat treatment. The resulting adhesion-promotion layer promotes adhesion of a subsequently applied second metal layer (e.g., a copper foil) to the ceramic substrate.

The first metal layer can be deposited on the ceramic substrate at a temperature of about 100° C. or less (e.g., at room temperature), and the heat treatment for forming the adhesion-promotion layer can be carried out while maintaining the temperature below the eutectic temperature of the oxide formed by the metal of the first metal layer (e.g., below the eutectic temperature of copper oxide—i.e., below 1065° C.). In an embodiment wherein the first metal layer is a copper film that is deposited on an aluminum nitride substrate, the adhesion-promotion layer includes copper oxide and copper aluminum oxide.

### BRIEF DESCRIPTION OF THE DRAWINGS

FIG. 1 is a sectional illustration of a substrate with an adhesion-promotion layer bonded to the substrate and with a metal layer bonded to the adhesion-promotion layer.

FIG. 2 is a flow chart illustrating a process for bonding a metal to a ceramic substrate.

FIG. 3 is a sectional illustration of a substrate with a metal film coated thereon.

FIG. 4 is an x-ray diffraction chart from x-ray diffraction performed on an adhesion promotion layer, with illustrated markers for copper aluminum oxide and for copper oxide.

FIG. 5 is a phase diagram for a binary system of aluminum oxide and copper oxide.

The foregoing and other features and advantages of the invention will be apparent from the following, more-particular description. In the accompanying drawings, like reference characters refer to the same or similar parts throughout the different views. The drawings are not necessarily to scale, emphasis instead being placed upon illustrating particular principles, discussed below.

### DETAILED DESCRIPTION

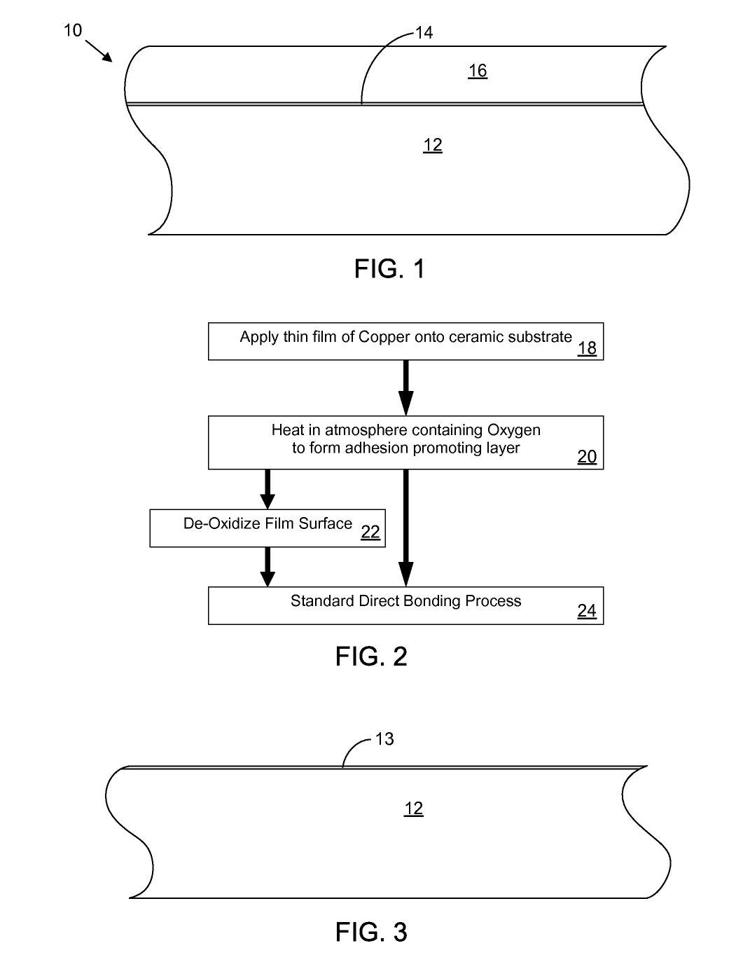

A metal-coated ceramic substrate 10 produced via methods described herein is illustrated in FIG. 1, wherein a ceramic substrate 12 is coated with an adhesion-promotion layer 14, and a metal-foil layer 16 is bonded to the adhesion-promotion layer 14.

Major steps in a process for forming the metal-coated substrate 10 of FIG. 1 are outlined in the flow chart of FIG. 2. In a first step 18, a thin film of metal 13 (shown in FIG. 3) is applied onto the ceramic substrate 12. In a following step 20, the metal film and ceramic substrate 12 are heated in an atmosphere containing oxygen to form an adhesion-promotion layer 14. The adhesion-promotion layer 14 can include oxides formed from metal ions both from the metal film and from the ceramic substrate reacted with the oxygen in the surrounding atmosphere. In an additional, optional step 22, the surface of the adhesion-promotion layer 14 can then be de-oxidized before bonding of the second metal layer 16. In a final step 24, the metal foil layer 16 (e.g., in the form of copper foil) is then applied to the adhesion-promotion layer 14 and bonded thereto via heat treatment. Embodiments of this process are discussed in further detail in the discussion and examples, provided below.

The ceramic substrate can be formed, e.g., of aluminum nitride (AlN), beryllium oxide (BeO), aluminum oxide (Al₂O₃), silicon nitride (Si₃N₄), boron nitride (BN), silicon aluminum oxynitride (SiAlON), aluminum oxynitride (AlON), an yttrium-aluminum-oxide compound (such as Y₃Al₅O₁₂, YAlO₃, or Y₄Al₂O₉), barium titanate (BaTiO₃), mullite (Al₆Si₂O₁₃), a ferrite, or combinations thereof.

The metal in the metal layers can be selected from, for example, copper, iron, chromium, nickel, cobalt and combinations thereof. The eutectic temperature for metal oxides of each of these metals is as follows:

copper-oxygen: 1065° C.;

iron-oxygen: 1523° C.;

chromium-oxygen: 1800° C.;

nickel-oxygen: 1438° C.; and

cobalt-oxygen: 1451° C.

Many of the examples and much of the discussion, provided herein, are focused on using copper as the metal and aluminum nitride as the substrate, though other materials can be substituted and the temperatures and other parameters can be adjusted based, for example, on the appropriate phase diagrams for the materials selected and upon the above-referenced eutectic temperatures (i.e., maintaining the temperature below the eutectic temperature for the pertinent metal oxide during the heat treatment to form the adhesion-promotion layer).

The first metal layer, from which the adhesion-promotion layer is formed, can be provided in the form of a film having a thickness, e.g., in the range of about 500 Angstroms to about 21,000 Angstroms (˜50 nm to 2.1 μm). The second metal layer that is then bonded to a side of the adhesion-promotion layer can be provided in the form of a foil having a thickness, e.g., in the range of about 0.003 inches to about 0.012 inches (˜76 μm to ˜305 μm). References, herein, to the “sides” of the substrate refer to the sides with the larger dimensions (e.g., the “sides” of an orthogonally shaped substrate having dimensions of 2 inches by 2 inches by 0.032 inches are the two 2-inch×2-inch surfaces).

Foils with thicknesses below this range can also be used if particular care is taken in conducting the process, as these particularly thin films typically are difficult to handle and easily consumed in the process absent tight controls over the oxygen content of the bonding atmosphere to prevent the foil from melting. On the other hand, foils with thicknesses above this range can be used if measures are taken to prevent warping of the substrate; typical ceramic substrates with a thickness of about 0.025 inches (˜635 μm) will often be warped by a bonded copper foil with a thickness greater than 0.012 inches (305 μm). For example, a copper composite, such as Cu—W (as described in U.S. Pat. No. 5,490,627), can be used for the metal foil to allow thicker metal layers to be bonded.

In specific embodiments, the thin copper film is deposited onto the ceramic substrate under vacuum conditions by evaporation or sputtering. In another embodiment, copper powder is fed into a plasma torch and subsequently sprayed onto the ceramic substrate. In still other embodiments, the layer including copper is applied to the substrate via screen printing, ink-jet printing, spin-coating, or other such methods.

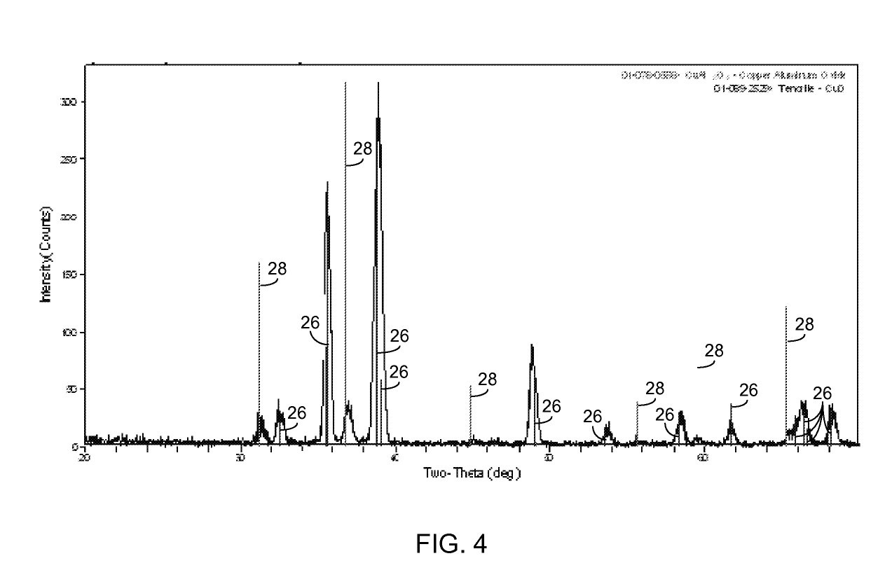

The copper-coated substrate is subsequently heated to an elevated temperature (e.g., 1,000° C.) below the eutectic temperature of the Cu/O system in the presence of oxygen (e.g., in air—i.e., at a N₂:O₂ ratio of about 80:20) to promote the formation of copper oxide(s) and other compounds, such as copper aluminum oxides, on the ceramic surface. A chart from an x-ray-diffraction analysis performed on a copper-coated ceramic substrate subject to such a treatment is provided as FIG. 4, and is further discussed in conjunction with the discussion under “Example 4,” infra. Respective markers for selected oxides that correspond with peaks in the x-ray-diffraction intensity counts across a range of angles are also shown in the chart. The copper oxide (CuO) markers 26 clearly correspond with the highest intensity peaks. The copper aluminum oxide (CuAl₂O₄) markers 28 also correspond with minor peaks in the chart (particularly evident at about 31° and at about 37°. These readings evidence that both CuO and CuAl₂O₄ were present in the adhesion-promotion layer.

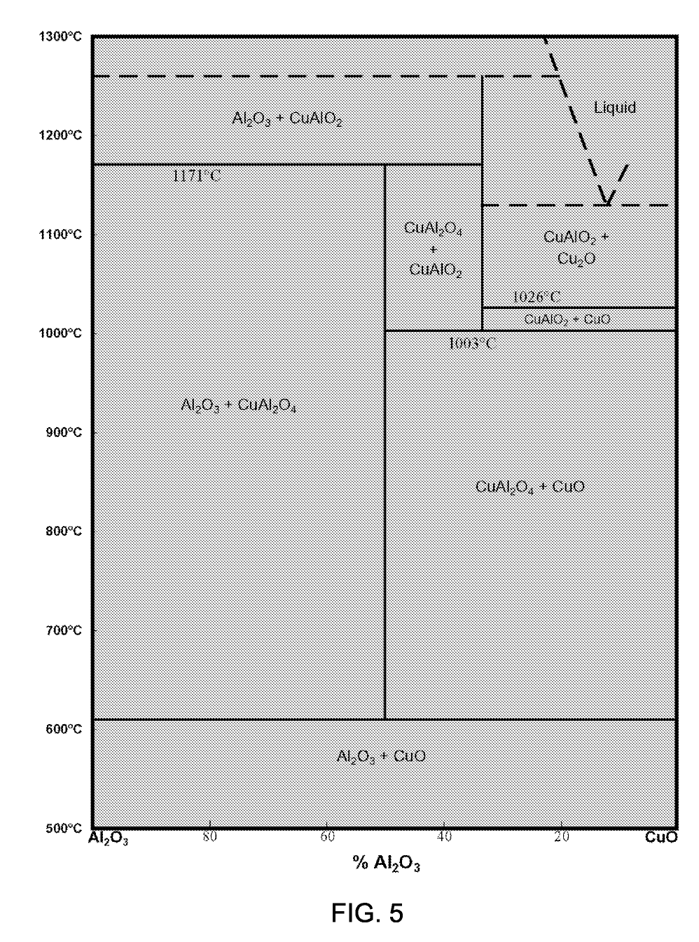

Based on the phase diagram, provided as FIG. 5, this oxidation of the copper to form a CuAlₓO_{y} compound can be carried out at a temperature in the range of about 600° C. to about 1270° C. In some cases, the substrate is then heated in a reducing atmosphere at a temperature up to about 300° C. (e.g., at 180° C.) to produce a copper-like surface (i.e., where most of the oxygen is removed to approach being pure metal copper) on top of the ceramic substrate.

When subsequently subjected to a bonding procedure, as described above, an un-grooved, solid copper foil adheres well to the ceramic substrate with few bubbles or blisters. The bond retains much of its strength even after repeatedly being subjected to a reducing environment.

The methods described herein can enable each of the following advantageous results: bonding of copper foil to aluminum-nitride substrates; formation of large-area, blister-free, bonded copper-to-ceramic substrates without needing to provide venting channels at the metal-substrate interface; and increased retention of bond strength of a bonded copper foil on a ceramic substrate after being subjected to reducing conditions.

The bonded metal-ceramic product of this process can then be further processed into a commercial product, e.g., for electronics applications. In a method for forming an integrated circuit, the metal foil (after bonding) is etched to produce a pattern in the metal via, e.g., photolithography. In photolithography, a layer of photoresist is applied and exposed to light in a selected pattern. The photoresist is then developed to remove either the exposed or unexposed areas of the photoresist. Next, an etching solution is applied to remove the metal in the areas of the pattern where the film is not covered by the remaining photoresist. Finally, the remaining photoresist is stripped from the remaining metal layer.

The copper-patterned surface, which can readily oxidize in storage, can be protected with a plated nickel and gold surface. For industrial companies that do not mind the cosmetic defects of oxidized copper, the substrates can have semiconductor or component devices soldered to the surface, with individual electrical components wire bonded using ultrasonic aluminum wire bonding directly to the copper. For higher-reliability and military applications, the copper surfaces are normally plated with nickel and gold to prevent surface oxidation and to allow gold wire bonding. The nickel layer is introduced as a barrier metal to prevent diffusion of the copper into the gold layers under soldering or brazing temperatures. The nickel can be either electrolytically plated or electrolessly plated. The electroless nickel can be plated on individual land areas of copper electrically isolated from each other without having to mechanically and electrically tie the individual circuit traces together. After nickel plating, the substrates can be electrolytically or electrolessly plated with a top gold layer for the final protective coating and to allow gold wire bonding interconnections.

Prior to wire bonding, the substrates are soldered or brazed into packages or assemblies; and semiconductor devices or other components are soldered to the plated copper circuit pads to provide a secure mechanical connection and a high rate of heat transfer. The attachment of a semiconductor die or component is often facilitated by soldering to the gold plated surface using a gold-containing solder (e.g., gold-silicon or gold-tin). Typical soldering conditions are 310° C. in a reducing atmosphere. Once the substrate with its semiconductor devices and components are mounted with solder or epoxy and the components are electrically connected into a circuit configuration, the package is normally sealed to protect it further from the elements. For industrial applications, some packages are sealed with epoxy encapsulants; or, in higher-reliability applications, the packages can be hermetically sealed with welded or solder lids.

The product is useful in particular applications, including, but not limited to, use with power semiconductors (i.e., circuits that handle high voltage and/or currents); as submounts for laser diodes used in optical communications; and in solid-state coolers (i.e., Peltier coolers).

### EXEMPLIFICATIONS

### Example 1

In this experiment, four aluminum nitride (AlN) substrates (each measuring 2 inches×2 inches×0.032 inches) were used. Copper was coated onto a side of two of the substrates (designated as 1A and 1B). The copper was coated via electron-beam evaporation of 7000 Å of copper in vacuum. The remaining two substrates (designated as 2A & 2B) were not coated with copper. All four substrates were subsequently heat treated (held in air at 1000° C. for 2 hours) simultaneously and then de-oxidized (held in 50:50 H₂:N₂ at 180° C. for 2 hr) simultaneously. Thus, the only significant or intentional difference in processing was inclusion of the copper-coating step.

Un-grooved, solid oxygen-free copper foils were bonded to one side of the ceramic substrates using standard conditions (“standard conditions” herein refer to a reducing atmosphere with low oxygen partial pressure and a temperature around 1070 to 1075° C. with a dwell time in the range of 1-10 minutes at the maximum temperature). Peel test samples were then formed (1-inch length by 0.5-inch width) by dicing the four substrates. Some of the as-bonded samples were then peel tested. Others were subjected to a reducing condition to simulate soldering (30:70 H₂:N₂, for 10 min at 350° C., 2 cycles). The average peel strength results for the substrates were as follows:

TABLE 1

| Sample | As-Bonded | Reduced |
|---|---|---|
| 1-A | 17.1 lbf/in | 19.4 lbf/in |
| 1-B | 20.5 lbf/in | 17.9 lbf/in |
| 2-A | NO BOND | |
| 2-B | NO BOND | |

Peel strength (as referenced here and elsewhere) was measured by bending back a portion of the copper foil until it was roughly perpendicular to the substrate. The sample was then mounted in a fixture, wherein the free end of the foil and the substrate were held in respective pairs of jaws. Similar to the operation of an Instron machine to measure tensile strength, a tensile stress was applied to pull the jaws apart, thereby peeling the foil from the substrate and measuring the applied stress throughout the process. Peel strength is defined as the average stress over a unit length (not area) when the combined structure fails.

From the above results, the following conclusions were drawn.

First, the deposition of copper was needed to form a strong bond with the process utilized. The only difference in processing between sample categories 1 versus 2 was the copper-deposition step. All subsequent processing steps (i.e., heat treatment and de-oxidation) were carried out on all substrates. As shown in the Table, above, those substrates not subjected to the copper deposition (i.e., the category-2 samples) did not bond to copper foil.

Second, the bond strength after reduction was not significantly degraded. The average strength of the as-bonded samples was 18.6 lbf/in, while that of the reduced samples was 18.7 lbf/in. Because of the small number of samples, only qualitative results are considered to be important.

### Example 2

In this experiment, a total of 22 AlN substrates (each measuring 2 inches×2 inches×0.032 inches) were used. Both sides of the substrates were coated with a 7000 Å copper film via electron-beam deposition under vacuum. All of the substrates were heat treated (held in air at 1000° C. for 2 hours) simultaneously. Some of the heat-treated substrates were de-oxidized (held in 50:50 H₂:N₂ at 180° C. for 2 hours).

Samples of un-grooved, solid oxygen-free copper foil with different thicknesses and surface states were used. Pre-oxidized copper foils having thicknesses of 0.003 inches, 0.005 inches, and 0.010 inches, as well as as-received (i.e., not intentionally oxidized) 0.010-inch thick copper foil were used. The same copper foils were bonded to both sides of the AlN substrates using standard conditions.

The bonded substrates were each diced into multiple peel-test specimens (1-inch length by 0.5-inch width). Some of the specimens were tested as-bonded (labeled, “Initial,” in the Table below), while others were subjected to a reducing condition (30:70 H₂:N₂, at temperature for 10 minutes, for two cycles) at 350° C. or 450° C. (not all combinations of variables were peel tested). The averaged results are given in the following Table:

TABLE 2

| | No. of | | Reduced - | Reduced - |
|---|---|---|---|---|
| Copper Foil | Substrates | Initial | 350° C. | 450° C. |
| Oxidized 0.003″ | 4 | 15.9 lbf/in | 10.4 lbf/in | |
| Oxidized 0.005″ | 4 | 14.9 lbf/in | 15.3 lbf/in | |
| Oxidized 0.010″ | 8 | 19.8 lbf/in | 19.2 lbf/in | 11.5 lbf/in |
| As-Received 0.010″ | 6 | 29.6 lbf/in | 28.3 lbf/in | 18.7 lbf/in |

### From these results, the following conclusions were drawn.

First, copper foil as thin as 0.003 inches and un-oxidized foil could be bonded to AlN.

Second, the bond strength after reduction was not significantly degraded. Even after reduction at 450° C., more than 50% of the initial bond strength remained.

### Example 3

In this experiment, 14 AlN substrates (2 inches×2 inches×0.032 inches) and three beryllium oxide (BeO) substrates (2.06 inches×2.06 inches×0.040 inches) were used. Both sides of the substrates were coated with a 7000 Å copper film via electron-beam deposition under vacuum. All of the substrates were heat treated (held in air at 1000° C. for 2 hours) simultaneously. Some of the heat-treated substrates were de-oxidized (held in 50:50 H₂:N₂ at 180° C. for 2 hr). The substrates were bonded with un-grooved, solid, pre-oxidized, 0.010-inch oxygen-free copper foil on both sides.

The bonded substrates were each diced into multiple peel-test specimens (1-inch length by 0.4-inch width). Some of the specimens were tested as-bonded (labeled, “Initial,” in the Table, below), while others were subjected to a reducing condition (30:70 H₂:N₂, “at Temperature” for 10 minutes, for 2 cycles) at 350° C. or 450° C. The averaged results are given in the following Table:

TABLE 3

| | De- | No. of | | Reduced - | Reduced - |
|---|---|---|---|---|---|
| Substrate | Oxidized? | Substrates | Initial | 350° C. | 450° C. |
| AlN | yes | 7 | 20.9 lbf/in | 19.6 lbf/in | 13.6 lbf/in |
| AlN | no | 7 | 28.6 lbf/in | 28.5 lbf/in | 17.7 lbf/in |
| BeO | yes | 2 | 29.5 lbf/in | 24.6 lbf/in | 10.2 lbf/in |
| BeO | no | 1 | 25.6 lbf/in | 30.0 lbf/in | 20.9 lbf/in |

In a demonstration, three AlN substrates (each 3 inches×3 inches) were coated with Cu powder using a plasma torch. These substrates were heat treated along with the above-mentioned substrates. The plasma-sprayed substrates were neither de-oxidized nor reduced. The plasma-sprayed substrates were tested solely to see if it was possible to bond with copper after plasma spraying. The substrates were bonded with un-grooved, solid, pre-oxidized, 0.012-inch, oxygen-free copper foil on one side. One of these three plasma-sprayed substrates displayed strong bonding to the copper foil, the peel strength was not measured.

From these results, the following conclusions were drawn.

First, the process worked with BeO substrates as well as with AlN substrates that were copper coated by plasma spraying.

Second, the bond strength after reduction was not significantly degraded. Even after reduction at 450° C., more than 60% of the initial bond strength remained for the AlN substrates.

### Example 4

In this experiment, a total of 18 AlN substrates were used. One side of each of the substrates was coated with a copper film via electron-beam deposition under vacuum. Six substrates were each coated with 5000 Å, 7000 Å, or 9000 Å of copper. The substrates were then heat treated (held in air at 900° or 1000° C. for 1, 2, or 4 hours), such that one substrate was fabricated with each of the 18 combinations listed below:

TABLE 4

| Copper | Held at 900° C. for | | | Held at 1000° C. for | | |
|---|---|---|---|---|---|---|
| Thickness | 1 hr | 2 hr | 4 hr | 1 hr | 2 hr | 4 hr |
| 5000 Å | • | • | • | • | • | • |
| 7000 Å | • | • | • | • | • | • |
| 9000 Å | • | • | • | • | • | • |

X-ray diffraction studies were performed on a portion of each of the 18 samples. In order to differentiate what was on the surface from the substrate itself, the technique of Grazing Incidence Diffraction was used. In this technique, the incident X-ray beam is directed nearly parallel to the sample surface (in this case, an incident angle of 0.5° was used).

All of the peaks in the subsequent diffraction results can be attributed to mixtures of CuO and CuAl₂O₄ on the surface of the substrates. One such example for a sample held at 100° C. for two hours is shown as FIG. 4, with markers for CuO peaks 26 and markers for CuAl₂O₄ peaks 28 illustrated. For the heat treatment conditions employed (held in air at 900° or 1000° C.), a mixture of CuO and CuAl₂O₄ is predicted from the Phase Diagram calculated by Jacob and Alcock in “Thermodynamics of CuAlO₂ and CuAl₂O₄ and Phase Equilibria in the System Cu₂O—CuO—Al₂O₃,” Journal of the American Ceramic Society, vol. 58, pp 192-195 (1975), and reproduced as FIG. 5.

### Example 5

This experiment was conducted simultaneously with Example 4. In order to determine the effect of heat treatment alone, a single AlN substrate without any copper film was held in air at 1000° C. for 2 hours.

Subsequent Grazing Incidence Diffraction results showed no peaks from copper compounds nor from any aluminum oxide or aluminum oxynitride phases. Only phases from the substrate, itself, were found.

### Example 6

In this experiment, a total of 22 AlN substrates measuring 3 inches×3 inches×0.25 inches were used. Both sides of each of the substrates were coated with a copper film. The method and thickness of film deposition were varied as follows:

TABLE 5

| No. of Substrates | Deposition Method | Copper Film Thickness |
|---|---|---|
| 6 | Evaporation | 7000 Å |
| 2 | Evaporation | 21,000 Å |
| 4 | Sputtering | 500 Å |
| 10 | Sputtering | 7000 Å |

The substrates were heat treated (held in air at 1000° C. for 2 hours) in a box-type furnace. Un-grooved, solid, oxygen-free copper foils were bonded to both sides of the heat-treated ceramic substrates using standard conditions.

In all cases, the copper foil adhered well with few if any bubbles.

### Example 7

This experiment was conducted simultaneously with Example 6. Two AlN substrates measuring 3 inches×3 inches×0.25 inches were used. Both sides of the substrates were coated with a 7000 Å copper film via sputtering under vacuum. In this experiment, the heat treatment was performed in a belt type furnace in air. The conditions were set to provide a maximum temperature of 1000° C. for approximately 10 minutes. Un-grooved, solid oxygen-free copper foils were bonded to both sides of the heat-treated ceramic substrates using standard conditions. The copper foil adhered to the substrates but with many bubbles, which may have been the result of excess oxygen.

### Example 8

One AlN substrate measuring 3 inches×3 inches×0.25 inches was used. Both sides of the substrate were coated with a 7000 Å copper film via electron-beam deposition under vacuum. The copper coated substrate was heated treated (held in air at 1000° C. for 2 hours). Un-grooved, solid oxygen-free copper foils were bonded to both sides of the heat treated ceramic substrates using standard conditions.

The bonded substrate was diced into several peel-test specimens (approximately 1-inch length by 0.4-inch width). Three of the specimens were subjected to thermal cycle testing (50 cycles from −65° C. to +150° C. with a 10 minute hold at the extremes with 15 minutes transit between extremes). These conditions were based upon Method 1010.8 of MIL-STD-883G, Test Condition C.

After thermal cycle testing, the copper foil remained adhered to the ceramic substrate. Peel testing was performed on the three specimens subjected to thermal cycle testing and compared to three samples cut from the same substrate which were not. The averaged results are given in the following Table:

TABLE 6

| Temperature Cycle | Peel Strength |
|---|---|
| None | 27.2 lbf/in |
| 50 cycles, −65° C. to +150° C. | 36.4 lbf/in |

The results show no degradation in adhesion after the Thermal Cycle Test.

In describing embodiments of the invention, specific terminology is used for the sake of clarity. For purposes of description, each specific term is intended to at least include all technical and functional equivalents that operate in a similar manner to accomplish a similar purpose. Additionally, in some instances where a particular embodiment of the invention includes a plurality of system elements or method steps, those elements or steps may be replaced with a single element or step; likewise, a single element or step may be replaced with a plurality of elements or steps that serve the same purpose. Moreover, while this invention has been shown and described with references to particular embodiments thereof, those skilled in the art will understand that various substitutions and alterations in form and details may be made therein without departing from the scope of the invention; further still, other aspects, functions and advantages are also within the scope of the invention. The contents of all references, including issued patents and published patent applications, cited throughout this application are hereby incorporated by reference in their entirety. The appropriate components, processes, and methods of those references may be selected for the invention and embodiments thereof.

What is claimed is:

1. A method of bonding a metal layer to a ceramic substrate:
providing a ceramic substrate, a first metal layer and a second metal layer;
applying the first metal layer onto the ceramic substrate;
heating the ceramic substrate with the first metal layer applied thereto in an atmosphere including oxygen to form an adhesion-promotion layer; and
bonding the second metal layer to the adhesion-promotion layer.

2. The method of claim 1, further comprising de-oxidizing the adhesion-promotion layer before bonding the second metal layer to it.

3. The method of claim 1, wherein the first metal layer is applied at a temperature of about 100° C. or less.

4. The method of claim 1, wherein the first metal layer comprises copper.

5. The method of claim 4, wherein the adhesion promotion layer includes copper oxide.

6. The method of claim 5, wherein the adhesion promotion layer further includes copper aluminum oxide.

7. The method of claim 5, wherein the ceramic substrate with the film applied thereto is heated to a temperature no greater than about 1,000° C.

8. The method of claim 1, wherein the ceramic substrate with the first metal layer is applied thereto is heated to a temperature below the eutectic temperature of the metal-oxide system.

9. The method of claim 1, wherein the substrate is a non-oxide ceramic.

10. The method of claim 1, wherein the substrate comprises aluminum nitride.

11. The method of claim 1, wherein the substrate comprises beryllium oxide.

12. The method of claim 1, wherein the substrate comprises aluminum oxide.

13. The method of claim 1, wherein the second metal layer comprises copper.

14. The method of claim 1, wherein the first metal layer is a film having a thickness in the range of about 50 nm to about 2.1 μm.

15. The method of claim 1, wherein the second metal layer is a foil having a thickness in the range of about 76 μm to about 305 μm.

16. A bonded metal-ceramic structure comprising:
a ceramic substrate;
an adhesion-promotion layer bonded to the ceramic substrate; and
a metal layer bonded to the adhesion-promotion layer,
wherein the adhesion-promotion layer includes a combined oxide of metals in each of the ceramic substrate and the metal layer.

17. The bonded metal-ceramic structure of claim 16, wherein:
the metal layer comprises copper;
the ceramic substrate comprises aluminum nitride; and
the adhesion-promotion layer comprises copper aluminum oxide.

18. The bonded metal-ceramic structure of claim 16, wherein the ceramic substrate is a non-oxide ceramic.
